(19) United States
(12) Patent Application Publication
(10) Pub. No.: US 2023/0129390 A1
(43) Pub. Date: Apr. 27, 2023

(54) DATA PROCESSING APPLICATION SYSTEM MANAGEMENT IN NON-STATIONARY ENVIRONMENTS

(71) Applicant: INTERNATIONAL BUSINESS MACHINES CORPORATION, Armonk, NY (US)

(72) Inventors: Francesco FUSCO, Maynooth (IE); Venkata Sitaramagiridharganesh GANAPAVARAPU, Elmsford, NY (US); Seshu TIRUPATHI, Dublin (IE)

(73) Assignee: INTERNATIONAL BUSINESS MACHINES CORPORATION, Armonk, NY (US)

(21) Appl. No.: 17/452,517

(22) Filed: Oct. 27, 2021

(51) Int. Cl. G06K 9/62; G06N 20/20

(52) U.S. Cl. CPC G06K 9/6257; G06K 9/6227; G06N 20/20

(57) ABSTRACT

Various embodiments are provided for managing performance of a data processing system in a computing environment using one or more processors in a computing system. A drift may be dynamically detected in one or more machine learning models generating a plurality of predictions and deployed in a computing system. A plurality of metrics and data may be collected of the one or more machine learning models based on the drift. One or more additional machine learning models may be trained based of the drift and the plurality of metrics and data.

### BACKGROUND OF THE INVENTION

### Field of the Invention

The present invention relates in general to computing systems, and more particularly to, various embodiments for managing performance of a data processing system in a non-stationary environment in a computing system using a computing processor.

### Description of the Related Art

Computing systems may be found in the workplace, at home, or at school. Due to the recent advancement of information technology and the growing popularity of the Internet, a wide variety of computer systems have been used in machine learning. Machine learning is a form of artificial intelligence that is employed to allow computers to evolve behaviors based on empirical data. Machine learning may take advantage of training examples to capture characteristics of interest of their unknown underlying probability distribution. Training data may be seen as examples that illustrate relations between observed variables. A major focus of machine learning research is to automatically learn to recognize complex patterns and make intelligent decisions based on data.

### SUMMARY OF THE INVENTION

According to an embodiment of the present invention, a method for managing performance of a data processing system in a non-stationary environment, by one or more processors, is depicted. A drift may be dynamically detected in one or more machine learning models generating a plurality of predictions and deployed in a computing system. A plurality of metrics and data may be collected of the one or more machine learning models based on the drift. One or more additional machine learning models may be trained based of the drift and the plurality of metrics and data.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 is an additional block diagram depicting an exemplary cloud computing environment according to an embodiment of the present invention.

FIG. 3 is an additional block diagram depicting abstraction model layers according to an embodiment of the present invention.

FIG. 4 is an additional block diagram depicting an exemplary functional relationship between various aspects of the present invention.

FIG. 5 is a block diagram depicting an exemplary system and functionality for managing performance of a data processing system in a computing environment by a processor in which aspects of the present invention may be realized.

FIG. 6A-6C is a diagram depicting exemplary graphical models of managing performance of a data processing system in a computing environment by a processor in which aspects of the present invention may be realized.

FIG. 7 is a diagram depicting exemplary pseudocode for managing performance of a data processing system in a computing environment in a computing environment by a processor in which aspects of the present invention may be realized.

### DETAILED DESCRIPTION OF THE DRAWINGS

The present invention relates generally to the field of artificial intelligence (“AI”) such as, for example, machine learning and/or deep learning. Machine learning allows for an automated processing system (a “machine”), such as a computer system or specialized processing circuit, to develop generalizations about particular data sets and use the generalizations to solve associated problems by, for example, classifying new data. Once a machine learns generalizations from (or is trained using) known properties from the input or training data, it can apply the generalizations to future data to predict unknown properties.

In machine learning and cognitive science, neural networks are a family of statistical learning models inspired by the biological neural networks of animals, and in particular the brain. Neural networks can be used to estimate or approximate systems and functions that depend on a large number of inputs and are generally unknown. Neural networks use a class of algorithms based on a concept of inter-connected “neurons.” In a typical neural network, neurons have a given activation function that operates on the inputs. By determining proper connection weights (a process also referred to as “training”), a neural network achieves efficient recognition of desired patterns, such as images and characters. Oftentimes, these neurons are grouped into “layers” in order to make connections between groups more obvious and to each computation of values. Training the neural network is a computationally intense process. For example, designing machine learning (ML) models, particularly neural networks for deep learning, is a trial-and-error process, and typically the machine learning model is a black box.

Currently, these techniques all require the ML model (e.g., neural network) to learn the structure in input data, which can make learning more difficult. For example, the current techniques using neural networks that consider structure include: 1) natural language process that may introspect the network after training to correlate high-level semantics to individual components of the network, 2) ResNets and/or DenseNets that may structure networks such that individual layers have access to different permutations and/or combinations of the input data; 3) attention networks that may allow some layers of the neural network structure to focus on a part of the input data; and/or 4) neural machine translation that may use an encoder-decoder neural network model where the encoder output exposes the structure in the input data and the model learns how to do this.

In many applications of artificial intelligence (“AI”), a machine-learning model is trained offline based on a historical sample of data and then deployed into production to generate predictions or insights from new online data samples. Non-stationary in the data can cause the performance of deployed machine-learning models to degrade over time due to drift in the data/target and changes in the environment. Drift, for example, may refer to an abnormal change or “drift.” For example, drift may occur when a machine learning model shifts from a normal or desired state, wherein the expected behavior of the machine learning model is consistently provided, to an abnormal or undesired state, wherein the expected behavior of the system is not consistently provided. Drift impacts machine learning model performance at different levels of severity, from inconsistent or decreased application/service-level functionality to complete machine learning model failure.

Accordingly, mechanisms of the illustrated embodiments provide a framework to automatically maintaining accuracy of machine-learning modelling task in production under non-stationary environments. In some implementations, an automated system is provided that generates multiple re-trained machine-learning models based on actively sampling of streaming production data and uses an ensemble of those models to avoid performance degradation with non-stationary data. In one aspect, “non-stationary” may refer to being unpredictable and cannot be modeled or forecasted. That is, non-stationary data may refer to data that is difficult to model because the estimate of a mean will be changing [and sometimes the variance]. For example, non-stationary data may relate to data traffic, data communication and/or patterns of moving data. More generally, such data relates to dynamic events occurring in the network, this including network intrusions. The non-stationary data may for instance include encrypted data, e.g., end-to-end encoded or encapsulated data flows, streams, or time-series. The non-stationary data may be defined as data that does not have constant statistical properties such as, for example, mean and variance over time.

In some implementations, the present invention provides for managing performance of a data processing system in a computing environment, by one or more processors, is depicted. A drift may be dynamically detected in one or more machine learning models generating a plurality of predictions and deployed in a computing system. A plurality of metrics and data may be collected of the one or more machine learning models based on the drift. One or more additional machine learning models may be trained based of the drift and the plurality of metrics and data.

In some implementations, the present disclosure provides for automatically managing performance of a data-processing software system. A software system calibration endpoint may be received. Real-time (e.g., live) Input/Output and performance data may be received from a multitude of running versions of the software system. Drift may be detected and measured where drift is a change in the data and/or software performance distribution.

In some examples, computing informativeness metrics indicating a degree of relevance and how informative the received live data are to improve the software performance. One or more samples of the Input/Output and performance quality data may be a collected based on drift metrics and sample informativeness metrics. A software system calibration endpoint may be triggered with collected Input/Output and performance samples, which will generate one or more new versions of the data-processing software system. In some aspect, the parameters of the ensemble models of all data-processing software system may be managed and updated by computing a ranking or weighting scheme.

In other variations, a performance management service provides for receiving a model training endpoint, live data scoring data, predictions and target data samples for a multitude of model scoring endpoints. The performance management service may detect and measure drift, where the drift is a change in the data and/or model performance distribution. The performance management service may determine/compute one or more drift metrics based on changes in model performance or distance between data samples or their statistics. The performance management service may compute information metrics based on how informative the received live data are to improve model performance. Also, the performance management service may actively sample from the scoring and target data based the drift metrics and the information metrics, by collecting the samples into a retrain data batch.

The performance management service may trigger a training endpoint with collected scoring and target data from the retrain data batch to generate one or more new re-trained models and scoring endpoints. The performance management service may update the ensemble prediction based on all available retrained models by computing a ranking or weighting scheme.

In some variations, one or more retrain data batches are collected based on data distance metrics and drift metrics and are therefore used to generate multiple retraining jobs. In some aspect, a user or machine learning model may optionally provide 1) a budget parameter to control a maximum number of trained models and scoring endpoints used at any time, 2) a desired target modelling score used to tune/adjust the change detection and retrain logic, and 3) a minimum retrain data sample size, and 4) a forgetting factor (or user configurable parameter) used to drop outdated models.

Also, it should be noted that one or more calculations may be performed using various mathematical operations or functions that may involve one or more mathematical operations (e.g., performing rates of change/calculus operations, solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

In general, as used herein, “optimize” may refer to and/or defined as “maximize,” “minimize,” or attain one or more specific targets, objectives, goals, or intentions. Optimize may also refer to maximizing a benefit to a user (e.g., maximize a trained machine learning model benefit). Optimize may also refer to making the most effective or functional use of a situation, opportunity, or resource.

Additionally, “optimize” need not refer to a best solution or result but may refer to a solution or result that “is good enough” for a particular application, for example. In some implementations, an objective is to suggest a “best” combination of preprocessing operations (“preprocessors”) and/or machine learning models, but there may be a variety of factors that may result in alternate suggestion of a combination of preprocessing operations (“preprocessors”) and/or machine learning models yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

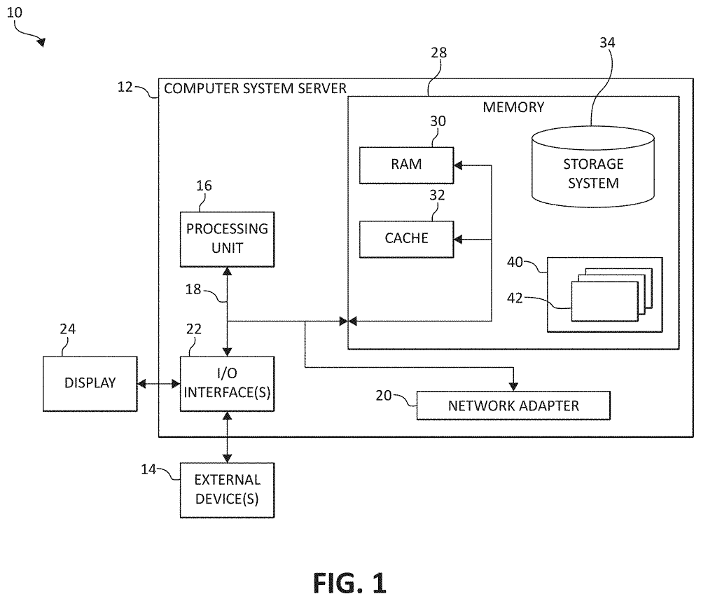

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

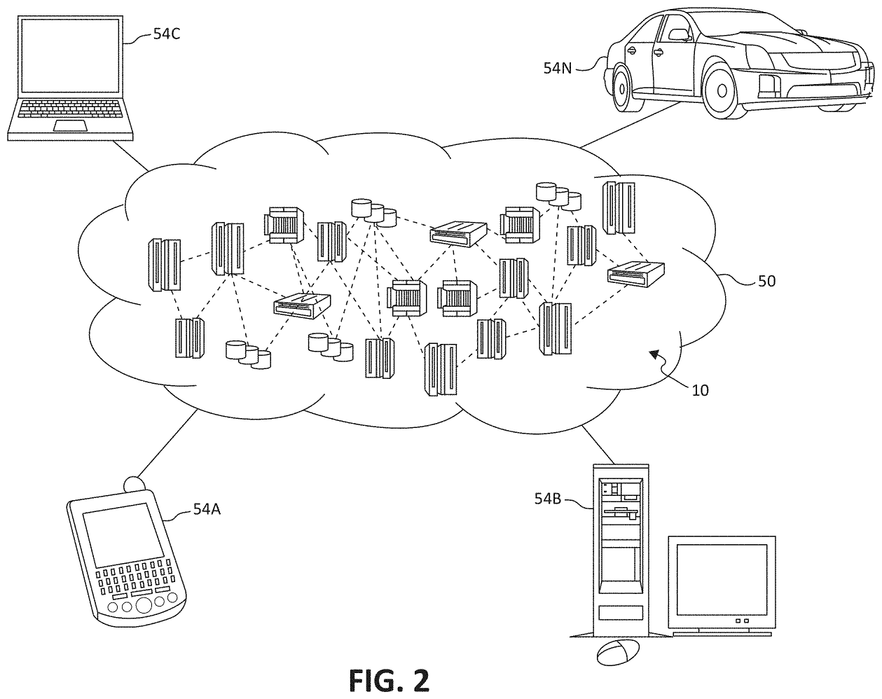

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

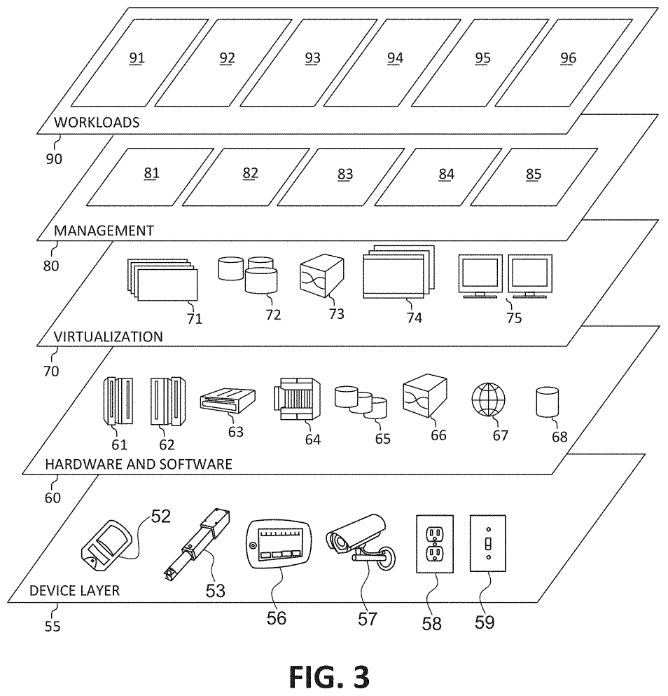

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for managing performance of a data processing system in a non-stationary environment in a computing system (e.g., in a neural network architecture). In addition, workloads and functions 96 for managing performance of a data processing system in a non-stationary environment in a computing system may include such operations as analytics, deep learning, and as will be further described, user and device management functions. One of ordinary skill in the art will appreciate that the workloads and functions 96 for managing performance of a data processing system in a non-stationary environment in a computing system in a computing environment may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously stated, the present invention provides novel solutions for managing performance of a data processing system in a computing environment in a computing system. A drift may be dynamically detected in one or more machine learning models generating a plurality of predictions and deployed in a computing system. A plurality of metrics and data may be collected of the one or more machine learning models based on the drift. One or more additional machine learning models may be trained based of the drift and the plurality of metrics and data.

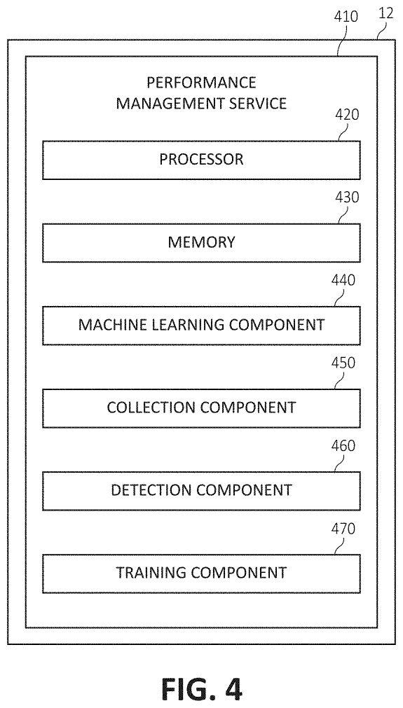

Turning now to FIG. 4, a block diagram depicting exemplary functional components of system 400 for managing performance of a data processing system in a computing system (in a non-stationary environment) in a computing environment according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

A performance management service 410 is shown, incorporating processing unit 420 (“processor”) to perform various computational, data processing and other functionality in accordance with various aspects of the present invention. In one aspect, the processor 420 and memory 430 may be internal and/or external to the performance management service 410, and internal and/or external to the computing system/server 12. The performance management service 410 may be included and/or external to the computer system/server 12, as described in FIG. 1. The processing unit 420 may be in communication with the memory 430. The performance management service 410 may include a machine learning component 440, a collection component 450, a detection component 460, and a training component 470.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

The performance management service 410 may, using the machine learning component 440, the collection component 450, the detection component 460, and the training component 470 may dynamically detect drift in one or more machine learning models generating a plurality of predictions and deployed in a computing system, collect a plurality of metrics and data of the one or more machine learning models based on the drift, and train one or more additional machine learning models based of the drift and the plurality of metrics and data.

The collection component 450 may collect model predictions, target data, sampled data, and one or more model parameters of the one or more machine learning models prior to detecting the drift. The training component 470 may update an ensemble of training data based on collecting the plurality of metrics and data of the one or more machine learning models, where the ensemble of training is used to train the one or more additional machine learning models or retrain the one or more machine learning models.

The collection component 450 may increase or decrease collection of the plurality of metrics and data of the one or more machine learning models based on dynamically detecting the drift.

The detection component 460 may detect the drift exceeds a drift threshold, wherein the drift is data drift or concept drift. The collection component 450 may track performance of the one or more additional machine learning models upon deployment in the computing system.

The machine learning component 440 may terminate use of the one or more machine models based on training the one or more additional machine learning models.

The machine learning component 440 may learn the label corruption probability of noisy labels for the selected data from the dataset using a machine learning operation. The dataset may a labeled dataset, an unlabeled dataset, a mislabeled dataset, or combination thereof.

In one aspect, the machine learning component 440, as described herein, may be perform various machine learning operations using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

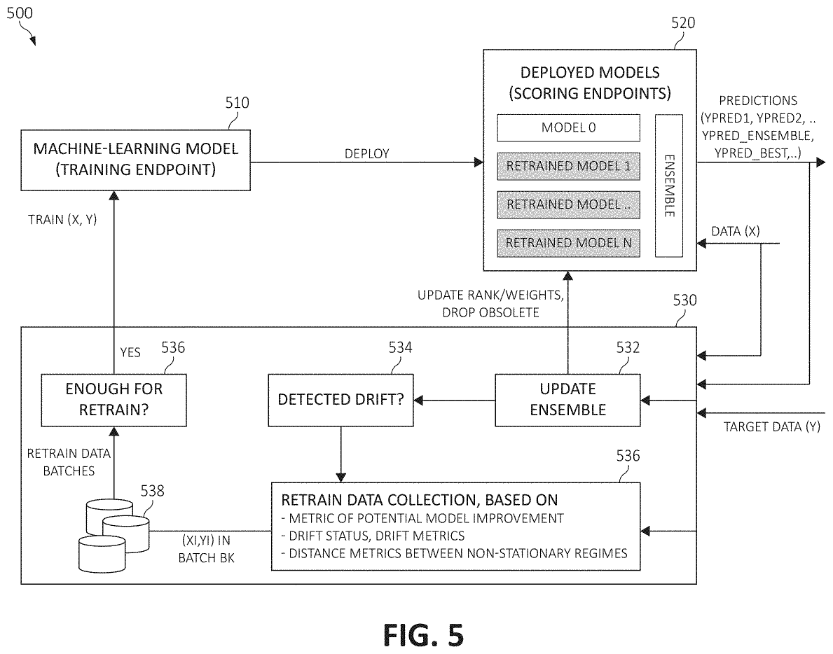

Turning now to FIG. 5, a block flow diagram depicts exemplary a system 500 and functionality for managing performance of a data processing system in a non-stationary environment in a computing environment in a computing environment. In one aspect, one or more of the components, modules, services, applications, and/or functions described in FIGS. 1-4 may be used in FIG. 5. As will be seen, many of the functional blocks may also be considered “modules” or “components” of functionality, in the same descriptive sense as has been previously described in FIGS. 1-4. Repetitive description of like elements employed in other embodiments described herein is omitted for sake of brevity.

As shown, the various blocks of functionality of system 500 are depicted with arrows designating the blocks' 500 relationships with each other and to show process flow. Additionally, descriptive information is also seen relating each of the functional blocks of system 500. As will be seen, many of the functional blocks of system 500 may also be considered “modules” or “components of functionality, in the same descriptive sense as has been previously described in FIGS. 1-4. With the foregoing in mind, the module blocks 500 may also be incorporated into various hardware and software components of a UMN system in accordance with the present invention. Many of the functional blocks 500 may execute as background processes on various components, either in distributed computing components, or on the user device, or elsewhere.

In one aspect, a performance management service 530 may be activated. One or more deployed machine-learning models 520, executing/running in production, may receive machine-learning model training endpoints from machine learning model 510. When invoked with a data sample (e.g., data (x)), the machine-learning model training endpoints from machine learning model 510 may train or “retrain” a machine-learning model (e.g., retrained model 1, . . . , N), and create a scoring endpoint. The performance management service 530 may receive live data samples and scoring results (e.g., model predictions). The performance management service 530 may receive live modelling target data (e.g., ground truth). Optionally, the performance management service 530 may receive an initial machine-learning model scoring endpoint 520. When invoked with a data sample, the endpoint will generate one or more model prediction such as, for example, predictions (Ypred1, Ypred2, Ypred_ensemble, Ypred_Best, . . . ,). It should be noted that the machine-learning model scoring endpoint 510 is depicted in a training phase while machine-learning model 520 is in a deployed phase. That is, the machine-learning model 520 may be the single machine learning model 510, which is now in a deployed phase, or may be an ensemble of machine-learning models.

The predictions may be transferred to the performance management service 530. The machine-learning model 520, which may include one machine learning model (e.g., machine learning model 0) or an ensemble of machine learning models (e.g., machine learning model 0 and retrained models 1, . . . , n), may be updated with the predictions, as in block 532. The updates improve the machine-learning model 520 to generate the predictions based on the detected drift.

The update may include updated ranks or weights and even obsolete parameters may be deleted or dropped. In block 534, the performance management service 530 may analyze the predictions and determine if the predictions contain any drift. In block 536, the performance management service 530 may retrain data (e.g., retain a collection of data) based on a plurality of factors, metrics, and parameters such as, for example, a metric of potential model improvements, drift status, drift metrics, and distance metrics between non-stationary data.

The data collection 538 (e.g., “data batches”) may be analyzed to determine whether there is sufficient data (e.g., enough data) for training the machine learning model 510, as in block 536.

Optionally, the performance management service 530 may receive user parameters such as, for example, a minimum amount of data for retraining and achieving a desired target metric for the modelling task. The performance management service 530 may automatically correct a machine-learning model(s) under non-stationary data, by: 1) detecting non-stationarity (e.g., drift) in the live data streams and/or in the production models performance, 2) sampling the live data based on drift metrics (e.g. distribution distance) and information metrics (e.g. model uncertainty) to populate multiple retrain data batches that will improve the modelling task under different non-stationary regimes, 3) generate new machine-learning models (e.g., scoring endpoints) by triggering the training endpoint on the retrain data batches of collected live data samples, 4) adjust a pool of re-trained machine-learning models to optimize prediction performance (e.g. model ranking, voting mechanism, drop obsolete models, etc.). Thus, the performance management service 530 may include deploying training and scoring endpoints of machine-learning model (e.g., a cloud service). A system is also provided for logging live model scoring data and target labels or ground truth such that, for example, generating retrain data batches and optimizing an ensemble of models may be for detecting drift.

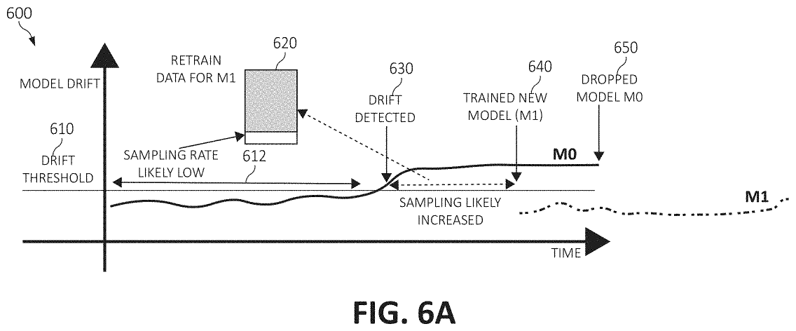

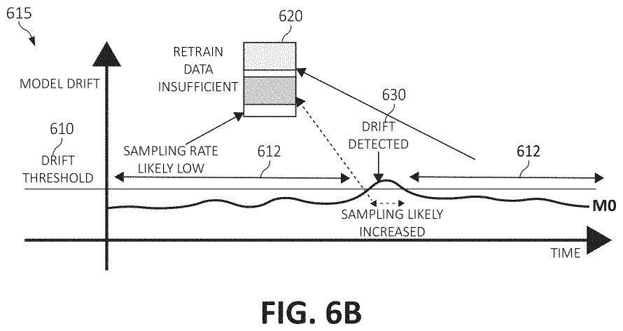

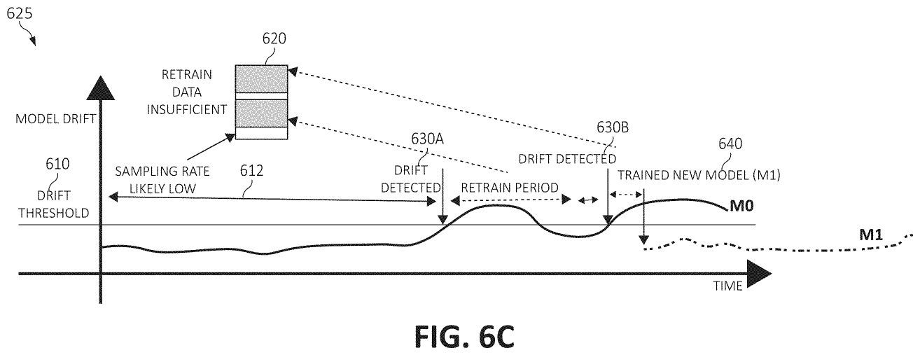

For further explanations, FIG. 6A-6C are diagrams 600, 615, and 625 depicting exemplary graphical models of managing performance of a data processing system.

For example, consider, as illustrated in graph 600 depicting model drift on the y-axis and time on the x-axis, consider a machine-learning model (“M0”) is provided/fed with live data (e.g., data that is generated in real time or in actual operation) and generating predictions over time. The performance management service (e.g., performance management service 530 of FIG. 5) may track a model drift time-series, which denotes an increased chance (e.g., likelihood) of a model error metric to be greater than expected or greater than a drift threshold.

After a period of time, drift is detected (e.g., drift event 630 is detected) where a drift model drift time-series is above a drift threshold 610, which means the error metric of model M0 higher than expected.

Prior to the drift event 630, a sampling rate 612 for collecting retrain may be relatively low as data are noninformative with respect to given thresholds (e.g., model uncertainty for those samples is very small, distribution distance from original training data small). After the drift event 630, the sampling rate for collecting retrain data 620 is likely low as data are further away from where M0 was trained (e.g., model uncertainty high, distribution distance from original training data high).

As time goes on, the system has been in a drift state long enough to collect sufficient data for training a new model such as, for example, machine learning model (“M1”). After a new model M1 has been trained, a new model drift timeseries may be tracked for machine learning model M1. Based on a performance metric of machine learning model M0 and M1, the data processing system updates the ensemble of machine learning models (e.g., M0, M1) such that predictions of M1 are preferred (e.g., higher rank, weight). After some time, M0 is still drifting and the system determines to drop the machine learning model M0, as depicted in the drop event 650.

As depicted in graph 615, before the drift event 630, a sampling rate 612 for collecting retrain data 620 substantially low as data are noninformative with respect to given thresholds (e.g., model uncertainty for those samples is very small, distribution distance from original training data small). After some time, a drift is detected (e.g., drift event 630 is detected) where a drift model drift time-series is above a drift threshold 610, which means the error metric of model M0 higher than expected.

During the drift event 630, the sampling rate 612 for collecting retrain data has increased but still substantially low as data are further away from where M0 was trained (e.g., model uncertainty high, distribution distance from original training data high). Shortly thereafter the system is no longer in the drift state. The sampling rate 612 for collecting retrain data is again reduced. However, there is insufficient data (e.g., not enough data) in the retrain data batch for training a new model such as, for example, a new machine learning model M1. During the period of time of no drift, live data samples are still considered for inclusion in the retrain data batch 620 if sufficiently informative on the model and if sufficiently close to the retrain data batch.

Turning now to graph 625, again, prior to occurrence of the drift event 630A, the sampling rate 612 for collecting retrain data is likely low as data are noninformative with respect to given thresholds (e.g., model uncertainty for those samples is very small, distribution distance from original training data small).

After some time, a drift is detected (e.g., drift event 630 is detected) where a drift model drift time-series is above a drift threshold 610, which means the error metric of model M0 higher than expected. During the drift event 630, the sampling rate 612 for collecting retrain data has increased but still substantially low as data are further away from where M0 was trained (e.g., model uncertainty high, distribution distance from original training data high).

Shortly thereafter, the system is no longer in the drift state. However, there is insufficient data (e.g., not enough data) in the retrain data batch for training a new model such as, for example, a new machine learning model M1. During a new drift event 630B, one or more samples are again being collected and added to an existing retrain data 620 batch. A new machine learning model 640 such as, for example, the machine learning model M1 is then trained.

In some implementations, the performance management service may decide whether enough training data is available, which could be either be based on a parameter of the user-provided training endpoint or could be automatically determined by the system. In some implementations, the performance management service may estimate the required training data size could be to use learning curves (e.g., train the model for increasing sizes of the training set and extrapolate learning curve based on cross-validation performance.) It should be noted that retrain data batches collected by the system may be composed of data under drift state and also data where the production model is performing as expected. The drift status and metrics can be used: 1) to set different thresholds for deciding whether a data point is included in a retrain data batch (e.g., be more aggressive when there is drift to react fast); and 2) to compile different retrain data batches addressing different non-stationary regimes of the data. As more models are retrained, the performance management service may automatically drop obsolete models. Dropping obsolete models can be based on a forgetting parameter, where models that performed well in the past are gradually eliminated over time as they fall below a threshold are dropped. A user-defined budget parameter can limit the number of re-trained models deployed at a given time.

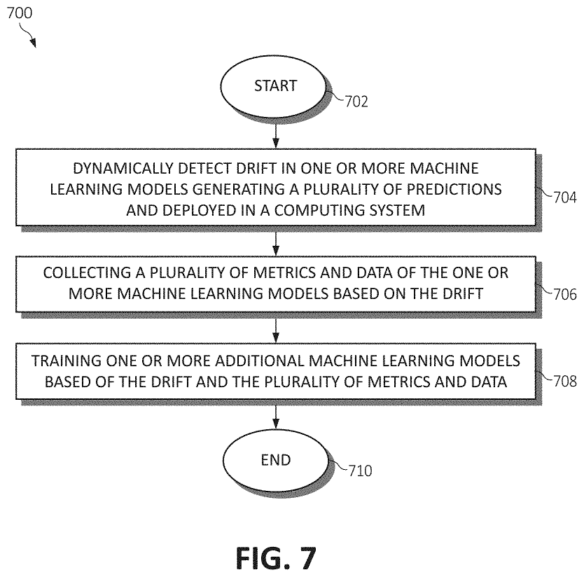

Turning now to FIG. 7, a method 700 for managing performance of a data processing system in a computing environment using a processor is depicted. The functionality 700 may be implemented as a method executed as instructions on a machine, where the instructions are included on at least one computer readable medium or one non-transitory machine-readable storage medium. The functionality 700 may start in block 702.

A drift may be dynamically detected in one or more machine learning models generating a plurality of predictions and deployed in a computing system, as in block 704. A plurality of metrics and data may be collected of the one or more machine learning models based on the drift, as in block 706. One or more additional machine learning models may be trained based of the drift and the plurality of metrics and data, as in block 708. The functionality 700 may end, as in block 710.

In one aspect, in conjunction with and/or as part of at least one blocks of FIG. 7, the operations of 700 may include each of the following. The operations of 700 may collect model predictions, target data, sampled data, and one or more model parameters of the one or more machine learning models prior to detecting the drift. The operations of 700 may update an ensemble of training data based on collecting the plurality of metrics and data of the one or more machine learning models, wherein the ensemble of training is used to train the one or more additional machine learning models or retrain the one or more machine learning models. The operations of 700 may increase or decrease collection of the plurality of metrics and data of the one or more machine learning models based on dynamically detecting the drift.

The operations of 700 may detect the drift exceeds a drift threshold, wherein the drift is data drift or concept drift. The operations of 700 may track performance of the one or more additional machine learning models upon deployment in the computing system. The operations of 700 may terminate use of the one or more machine models based on training the one or more additional machine learning models.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for managing performance of a data processing system in a computing environment using one or more processors comprising:
dynamically detecting drift in one or more machine learning models generating a plurality of predictions and deployed in a computing system;
collecting a plurality of metrics and data of the one or more machine learning models based on the drift;
training one or more additional machine learning models based of the drift and the plurality of metrics and data.

2. The method of claim 1, further including collecting model predictions, target data, sampled data, and one or more model parameters of the one or more machine learning models prior to detecting the drift.

3. The method of claim 1, further including updating an ensemble of training data based on collecting the plurality of metrics and data of the one or more machine learning models, wherein the ensemble of training is used to train the one or more additional machine learning models or retrain the one or more machine learning models.

4. The method of claim 1, further including increasing or decreasing collection of the plurality of metrics and data of the one or more machine learning models based on dynamically detecting the drift.

5. The method of claim 1, further including detecting the drift exceeds a drift threshold, wherein the drift is data drift or concept drift.

6. The method of claim 1, further including tracking performance of the one or more additional machine learning models upon deployment in the computing system.

7. The method of claim 1, further including terminating use of the one or more machine models based on training the one or more additional machine learning models.

8. A system for managing performance of a data processing system in a computing environment, comprising:
one or more computers with executable instructions that when executed cause the system to:
dynamically detect drift in one or more machine learning models generating a plurality of predictions and deployed in a computing system;
collect a plurality of metrics and data of the one or more machine learning models based on the drift; and
train one or more additional machine learning models based of the drift and the plurality of metrics and data.

9. The system of claim 8, wherein the executable instructions when executed cause the system to collect model predictions, target data, sampled data, and one or more model parameters of the one or more machine learning models prior to detecting the drift.

10. The system of claim 8, wherein the executable instructions when executed cause the system to update an ensemble of training data based on collecting the plurality of metrics and data of the one or more machine learning models, wherein the ensemble of training is used to train the one or more additional machine learning models or retrain the one or more machine learning models.

11. The system of claim 8, wherein the executable instructions when executed cause the system to increase or decrease collection of the plurality of metrics and data of the one or more machine learning models based on dynamically detecting the drift.

12. The system of claim 8, wherein the executable instructions when executed cause the system to detect the drift exceeds a drift threshold, wherein the drift is data drift or concept drift.

13. The system of claim 8, wherein the executable instructions when executed cause the system to track performance of the one or more additional machine learning models upon deployment in the computing system.

14. The system of claim 8, wherein the executable instructions when executed cause the system to terminate use of the one or more machine models based on training the one or more additional machine learning models.

15. A computer program product for increasing trustworthiness of an accelerator in heterogenous systems in a computing environment, the computer program product comprising:
one or more computer readable storage media, and program instructions collectively stored on the one or more computer readable storage media, the program instruction comprising:
program instructions to dynamically detect drift in one or more machine learning models generating a plurality of predictions and deployed in a computing system;
program instructions to collect a plurality of metrics and data of the one or more machine learning models based on the drift; and
program instructions to train one or more additional machine learning models based of the drift and the plurality of metrics and data.

16. The computer program product of claim 15, further including program instructions to collect model predictions, target data, sampled data, and one or more model parameters of the one or more machine learning models prior to detecting the drift.

17. The computer program product of claim 15, further including program instructions to update an ensemble of training data based on collecting the plurality of metrics and data of the one or more machine learning models, wherein the ensemble of training is used to train the one or more additional machine learning models or retrain the one or more machine learning models.

18. The computer program product of claim 15, further including program instructions to increase or decrease collection of the plurality of metrics and data of the one or more machine learning models based on dynamically detecting the drift.

19. The computer program product of claim 15, further including program instructions to detect the drift exceeds a drift threshold, wherein the drift is data drift or concept drift.

20. The computer program product of claim 15, further including program instructions to:
track performance of the one or more additional machine learning models upon deployment in the computing system; and
terminate use of the one or more machine models based on training the one or more additional machine learning models.
